(19) United States
(12) Patent Application Publication
(10) Pub. No.: US 2009/0060685 A1
(43) Pub. Date: Mar. 5, 2009

(54) All-Terrain Log Forwarder

(76) Inventor: Howard Godfrey, Andover, OH (US)

Correspondence Address: EDWARD W. GOEBEL, JR.;MACDONALD, ILLIG, JONES & BRITTON LLP, 100 STATE STREET, SUITE 700, ERIE, PA, 16507-1498, US

(21) Appl. No.: 11/847,594

(22) Filed: Aug. 30, 2007

(51) Int. Cl. B66F 11/00

(52) U.S. Cl. 414/23; 414/469

(57) ABSTRACT

A log forwarder comprising a chassis having two sides, a separate series of rollers mounted substantially along the length of each side of the chassis, each series of rollers having an endless track made substantially of elastomeric material that extends around the rollers so as to contact the ground, with the series of rollers extending the ground contact area and weight distribution substantially along the length of the log forwarder, a flat bed for receiving logs; a covered cab; a boom adjacent said covered cab adaptable for moving logs to and from the flat bed, the covered cab including within it a first set of controls for maneuvering the log forwarder and a second set of controls for manipulating the boom, and the log forwarder having a height and a width which are less than height and width dimensions that require a road travel permit.

### BACKGROUND

Tree harvesting and logging operations are often conducted in hard-to-reach areas with difficult terrain or through areas in which minimum disruption is sought. Often large vehicles and heavy equipment are used that tear up the upper soil layer and create muddy messes that are difficult to navigate over and difficult to restore. Heavy logging vehicles also compact the lower soil layers making it difficult for the roots of vegetation to penetrate the soil and make it harder for trees to grow back into a logged site.

Once a tree is cut down, the logs are extracted from the site. Often skidders, bulldozers, or even horses are used to merely drag the logs along the ground. Such dragging damages the logs and further tears up the upper soil layers. However, log forwarders that carry the logs out instead of dragging them are sometimes used. Most forwarders are wheeled which limits their utility in muddy locations. Wheeled vehicles and horse teams have limited utility in wet and winter weather. This limits the ability of loggers to conduct operations over a significant portion of the year. The tracked vehicles that are in use often have steel tracks that are not much gentler on the terrain. Both wheels and steel tracks are known to cut into the root mass of trees as they maneuver around a logging site. This severely damages the surrounding vegetation, which reduces the capacity of trees to grow and sometimes destroys existing vegetation outright.

Heavy equipment described above is usually transported between logging sites by loading the equipment on the flat beds of trucks. This is time consuming and requires the owner or operator of the equipment to spend significant time filling out paperwork for transportation permits. This is especially true if the machines loaded onto a transportation vehicle exceed legal height and width restrictions for transport on highways. Shipping and freight that exceeds these limits must obtain permissions and permits in order to travel on state and federal highways. This represents a significant delay and overhead to ensure compliance with appropriate transportation regulations.

### SUMMARY

A log forwarder is provided. The chassis of the log forwarded has two sides. Each side has a separate series of rollers mounted substantially along the length of the chassis. Each series of rollers has an endless track made substantially of elastomeric material that extends around the rollers so as to contact the ground. The series of rollers extends the ground contact area and weight distribution substantially along the length of the log forwarder. The log forwarder has a flat bed for receiving longs, a covered cab, and a boom adjacent the covered cab adaptable for moving logs to and from the flat bed. A covered cab includes within it a first of set of controls for maneuvering the log forwarder and a second set of controls for manipulating the boom. The log forwarder is of a height and a width that is less than height and width dimensions that require a road travel permit.

In one embodiment, the covered cab area swivels with the boom. The controls in the covered cab can be arranged in many ways. In one embodiment, the first set of controls for maneuvering the log forwarder is oriented towards the front of the log forwarder and the second set of controls for manipulating the boom oriented is towards the back of the log forwarder. The second set of controls can include controls for maneuvering the log forwarder as well. The covered cab can include an adjustable seat that may be oriented to provide access to either the first set of controls or the second set of controls. Alternatively the covered cab can have a seat oriented forward to provide access to the first set of controls and a second seat oriented towards the back to provide access to the second set of controls.

Those skilled in the art will realize that this invention is capable of embodiments different from those shown and described herein and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a perspective view of the front of the log forwarder;

FIG. 2 is a perspective view of the rear of the log forwarder of FIG. 1;

FIG. 3 is a side view of the log forwarder of FIG. 1;

FIG. 4 is a frontal view of the log forwarder of FIG. 1;

FIG. 5 is a view of one embodiment of the inside of the covered cab having one set of controls oriented towards the from of the log forwarder for maneuvering the log forwarder, a second set of controls oriented towards the back of the log forwarder for manipulating the boom, and an adjustable seat to access both sets of controls;

FIG. 6 is a view of one embodiment of the inside of the covered cab having one set of controls oriented towards the from of the log forwarder for maneuvering the log forwarder, a second set of controls oriented towards the back of the log forwarder for manipulating the boom, and separate seats for accessing each set of controls;

FIG. 7 is a perspective view of the front of a different embodiment of log forwarder with a covered cab that swivels with the boom;

FIG. 8 is a perspective view of the rear of the log forwarder of FIG. 7;

FIG. 9 is a side view of the log forwarder of FIG. 7; and

FIG. 10 is a frontal view of the log forwarder of FIG. 7.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

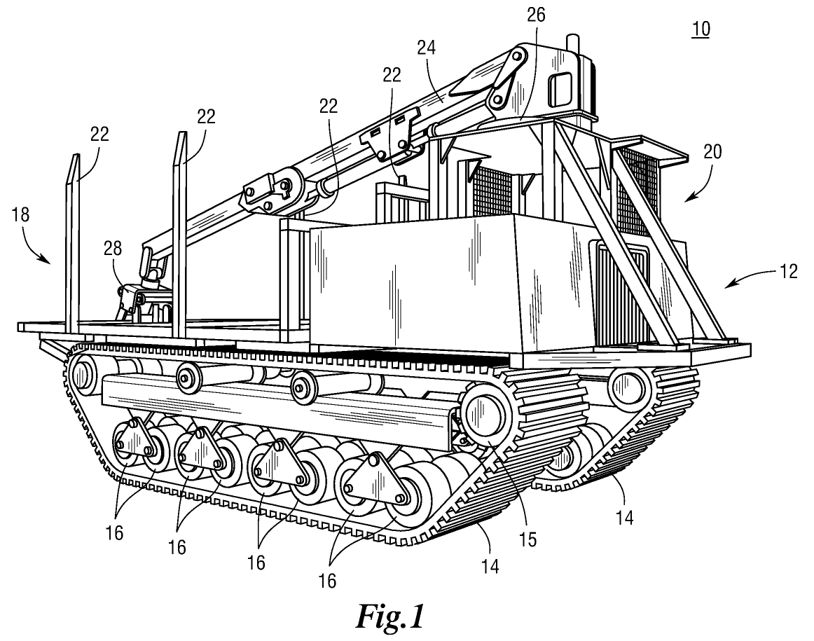

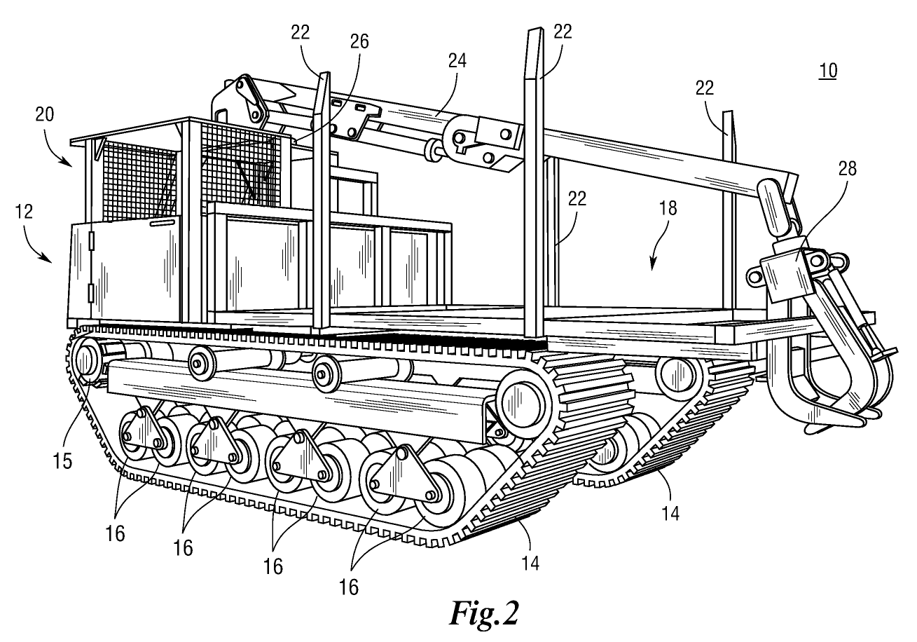

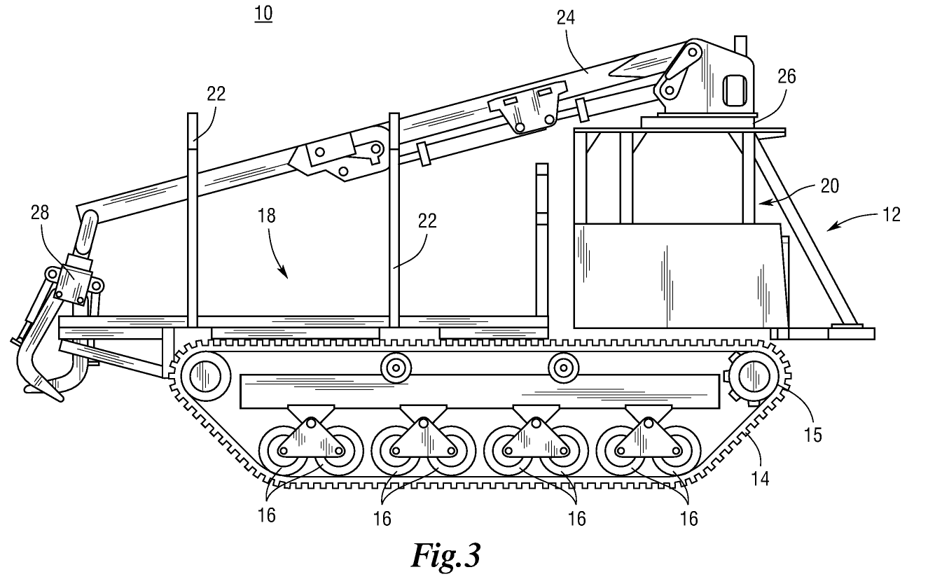

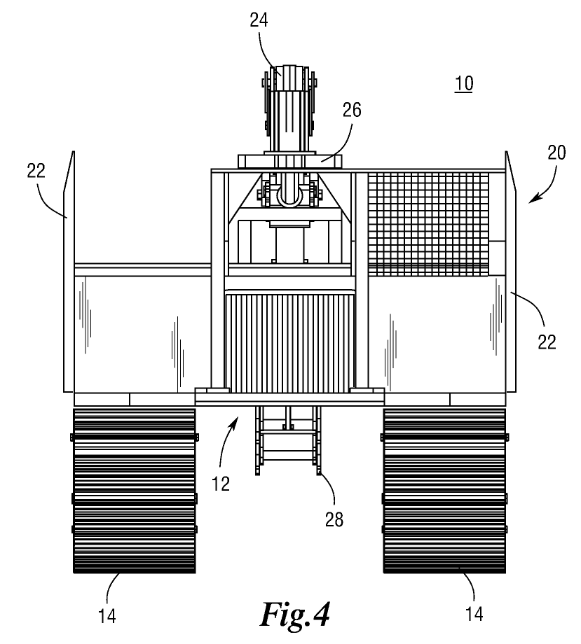

As can be best understood by comparing FIGS. 1 through 4, the log forwarder 10 comprises a chassis 12 that has a number of rollers 16 mounted substantially along the length of each side of the chassis 12. FIGS. 1 through 4 show the log forwarder 10 with eight roller 16 but a greater or lesser number of rollers can 16 also be used. Also, while the roller 16 are not shown along the total length of the chassis 12, it will be understood that variations of log forwarders 10 can have rollers 16 along the total length of the chassis 12. Each series of rollers 16 has an endless track 14 made substantially of elastomeric material that extends around the rollers 16 so as to contact the ground. The rollers 16 extend the ground contact area and weight distribution of the log forwarder 10.

The log forwarder 10 has a flat bed 18 located behind a covered cab 20 for receiving logs. The flat bed 18 has vertical supports 22 to help retain stored material on the flat bed 18, but other support elements could be used, such as side walls, fence frames, netting, or other appropriate devices.

A boom 24 is mounted on a swivel base 26—in this example the swivel base 26 is mounted on top of the covered cab 20. FIGS. 1 through 4 show the boom 24 equipped with a log grapple apparatus 28 for lifting and moving felled logs. In particular, log grapple apparatus 28 shown is a pair of claws, but any other type of log grapple apparatus 28 may be used such as a hook, a clamp, or other appropriate devices. The boom 24 can be fitted with a platform that can be used to elevate a worker to inspect or trim trees. This would make the log forwarder 10 additionally functional for the tree service industry. The boom 24 is mounted in such a position that when the boom 24 is in use, the center of gravity of the log forwarder 10 would not cause the vehicle to topple over.

The endless tracks 14 are preferably made of an elastomeric material such as rubber. Each endless track 14 may be a single flexible belt as shown in FIGS. 1 through 4 or may comprise a number of units that are joined to each other. The endless tracks 14 can incorporate metal reinforcement plates (not shown) or other metal reinforcement structures. Each endless track 14 is moved by a toothed drive wheel 15 that is driven by the log forwarder's 10 engine. The log forwarder's 10 weight is transferred to the bottom length of the endless track 14 by the rollers 16. The endless tracks 14 help distribute the weight of the log forwarder 10 more evenly over a larger surface area than wheels can.

The tracked log forwarder 10 has better mobility over rough terrain than similar vehicles with pneumatic tires. The endless tracks 14 are much less likely to get stuck in soft ground, mud, or snow, since they distribute the weight of the vehicle over a larger contact area, thereby decreasing its ground pressure. The endless tracks 14 of the embodiment of log forwarder 10 shown in FIGS. 1 though 4 are about 28 inches wide. This gives the log forwarder 10 about 7,392 square inches of ground contact area for a ground pressure of about 2.98 pounds per square inch (psi) when it is empty and about 4.6 to 5.0 psi when loaded, depending on the size of the load. Increasing the width of the endless tracks 14 will further increase the log forwarder's 10 ground contact area and decrease its ground pressure.

The elastomeric material of the endless tracks 14 provides improves traction and reduces soil compaction over similar tracks made of steel or metal and allows the log forwarder 10 to relocate itself on public roads without damaging the road surface.

Prolonged use of normal heavy logging machines and vehicle places enormous strain on the drive transmissions and the mechanics of the vehicles, which must then be overhauled or replaced regularly. In order to reduce wear and tear, it is common to transport this equipment long distances by a wheeled carrier such as a semitrailer or train. Most equipment transported in such a manner exceeds federal and state height and width restrictions. In the United States, height restrictions are imposed at the state level. According to the United Stated Department of Transportation Federal Highway Administration, vehicle height limits in most states range from 13.6 feet to 14.6 feet. Federal regulations require that no state may impose a width limitation of other than 102 inches (8.5 feet) not including safety devices such as mirrors, handholds, etc. Shipping and freight that exceeds these limits must obtain permissions and permits in order to travel on state and interstate highways. This represents a significant delay and overhead to ensure compliance with appropriate transportation regulations.

The log forwarders 10 presented herein have a height and a width that are less than height and width dimensions that require a road travel permit. The embodiments of log forwarders 10 presented herein can be constructed to be no more than about 8.5 feet wide and no more than about 13.6 feet high. In particular, the embodiment shown in FIGS. 1 though 4 has a height no about 13.6 feet when loaded onto a standard transportation vehicle having a 36-inch high cargo deck. The small size of the log forwarder 10 also translates into a lighter vehicle that has less impact on the soil in a logging site.

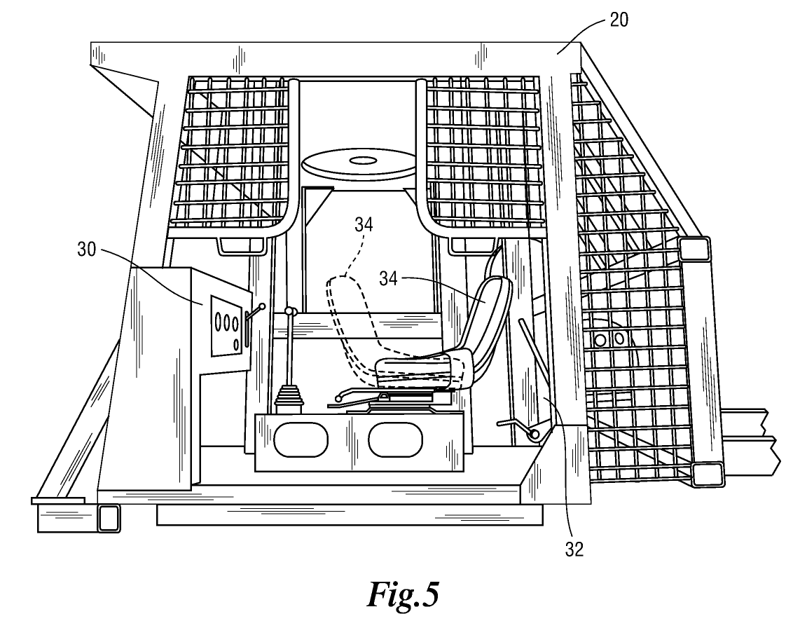

As shown in FIG. 5, the covered cab 20 includes a first set of controls 30 oriented towards the front of the log forwarder 10 for maneuvering the log forwarder 10 and a second set of controls 32 for manipulating the boom 24. The embodiment depicted in FIG. 5 shows the covered cab 20 having an adjustable seat 34 that can be swiveled and locked in place so that an operator may access either the first set of control 30 or the second set of controls 32 from the same seat 34. For ease of operation, the second set of controls 32 can also include secondary controls for maneuvering the log forwarder 10. This would allow an operator using the second set of controls 32 to maneuver the log forwarder 10 into a more favorable position to operate the boom 24 without having to swivel the adjustable seat 34.

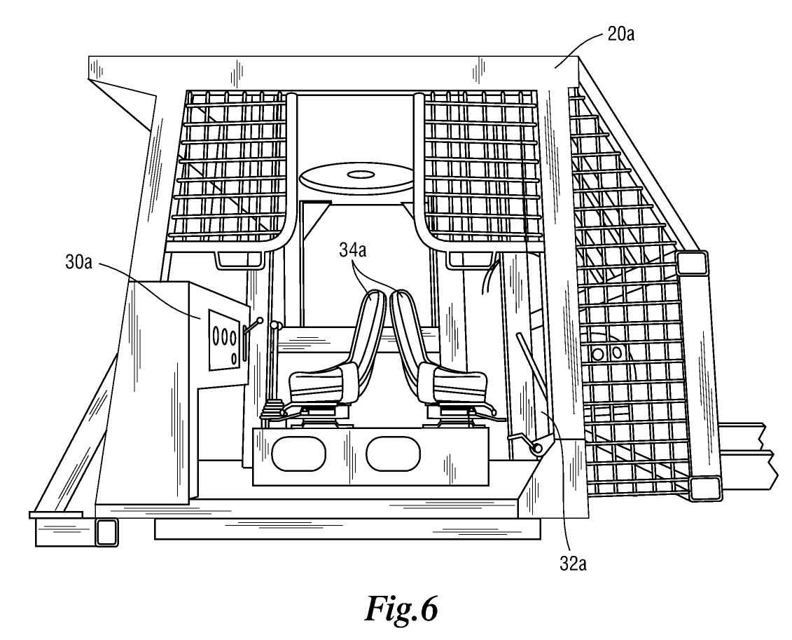

As shown in FIG. 6, it is possible to design a covered cab 20a having two separate seats 34a, one facing the forward for access to the first set of controls 30a and one facing backwards to access the second set of controls 32a.

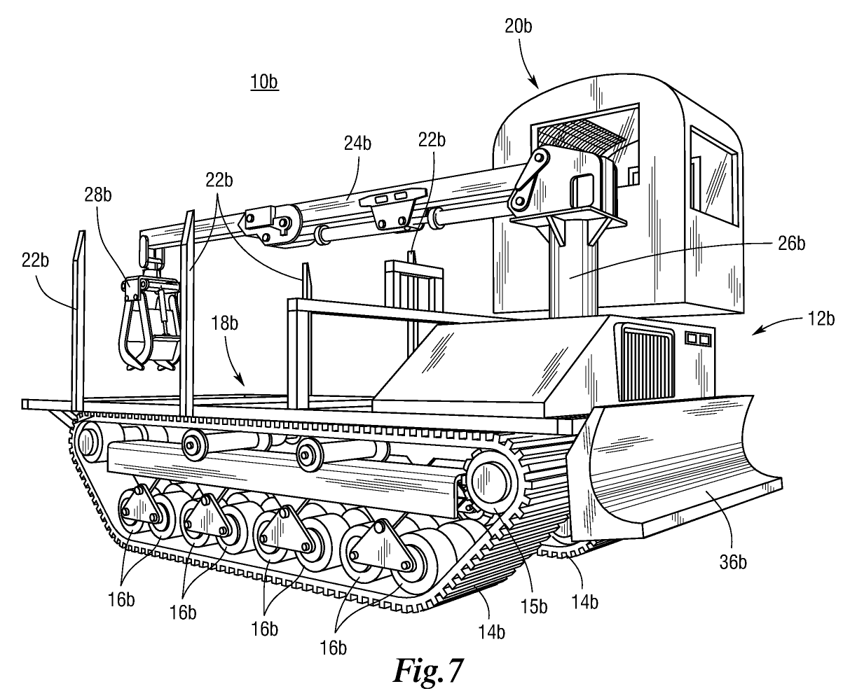

The line of sight from the covered cab 20 shown in FIGS. 1 through 4 has some areas that necessitate the operator move his head to get a clear view. The embodiment of log forwarder 10b shown in FIGS. 7 though 10 improves the operator's view during operation of the boom 24b. The covered cab 20b and the boom 24b are co-axially mounted on a swivel base 26b. In the operation of the boom 24b, the covered cab 20b and the boom 24b swivel as one. If necessary, the covered cab 20b can tip forward with hydraulic cylinders (not shown) to achieve legal transportation height.

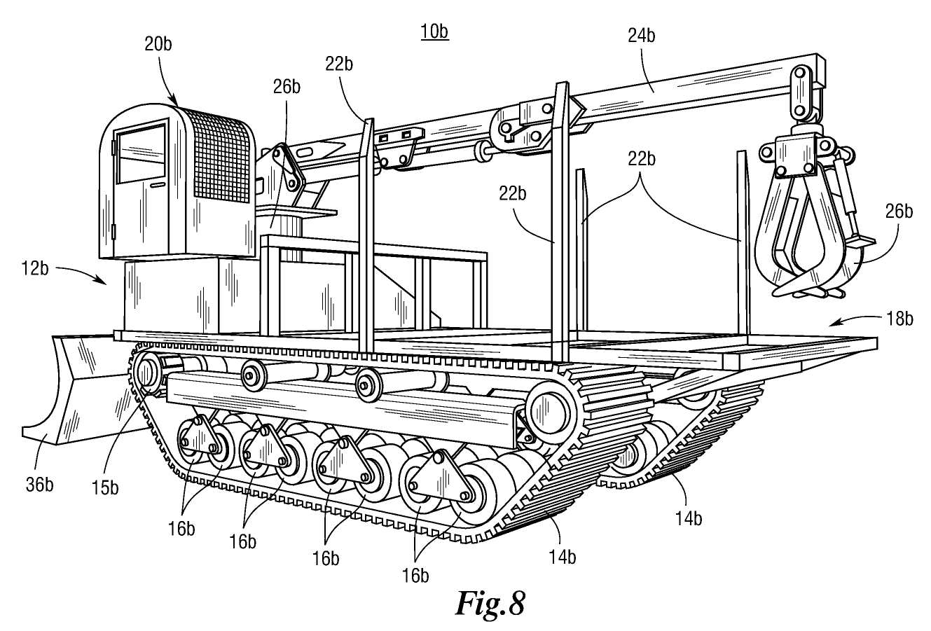

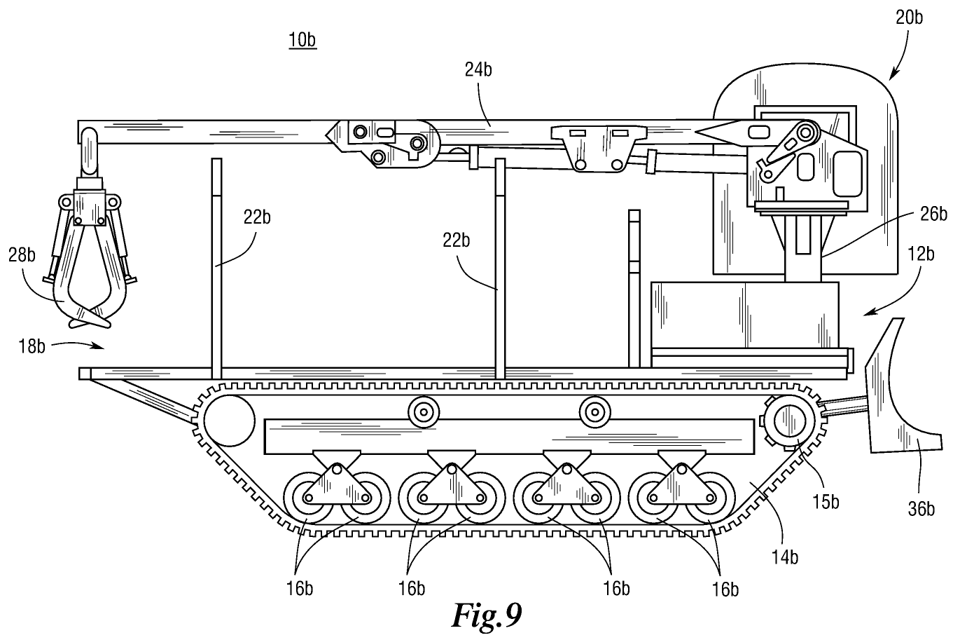

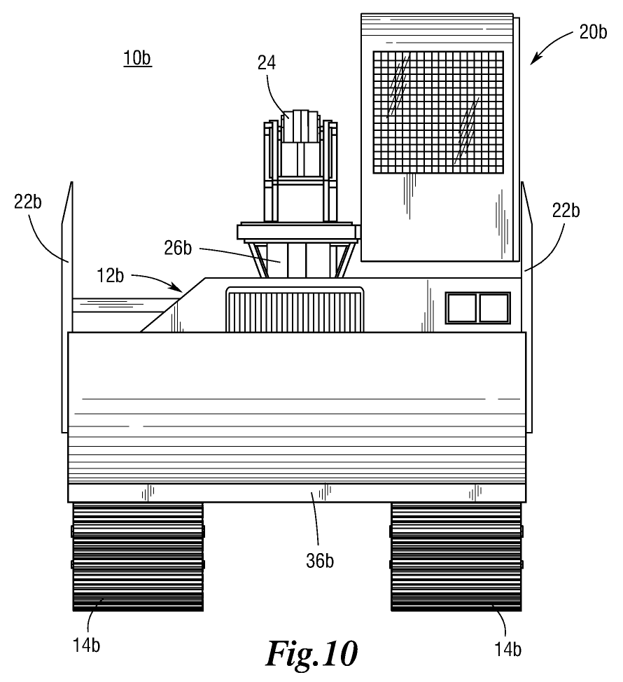

FIGS. 7 through 10 show the boom 24b equipped with a log grapple apparatus 28b for lifting and moving felled logs. In particular, log grapple apparatus 28b shown is a pair of claws, but any other type of log grapple apparatus 28b may be used such as a hook, a clamp, or other appropriate devices. The boom 24b can also be fitted with a platform that can be used to elevate a worker to inspect or trim trees. This would make the log forwarder 10b additionally functional for the tree service industry.

A dozer blade 36b may be optionally attached to the log forwarder 10b to provide additional functionality. The dozer blade 36b can be used to move obstacles from the path of the log forwarder 10b, to move dirt or other debris, to reposition logs, etc. Other equipment such as a winch (not shown) may be optionally included instead or as well

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A log forwarder comprising:
a chassis having two sides; a separate series of rollers mounted substantially along the length of each side of the chassis; each series of rollers having an endless track made substantially of elastomeric material that extends around the rollers so as to contact the ground, with the series of rollers extending the ground contact area and weight distribution substantially along the length of the log forwarder;
a flat bed for receiving logs;
a covered cab;
a boom adjacent said covered cab adaptable for moving logs to and from said flat bed;
said covered cab including within it a first set of controls for maneuvering said log forwarder and a second set of controls for manipulating said boom; and
said log forwarder having a height and a width which are less than height and width dimensions that require a road travel permit.

2. The log forwarder of claim 1 in which said covered cab area swivels with said boom.

3. The log forwarder of claim 1 in which a log grapple apparatus is attached to said boom, said log grapple apparatus selected from the group comprising a pair of claws, a hook and chains, and a clamp.

4. The log forwarder of claim 1 in which a platform is attached to said boom.

5. The log forwarder of claim 1 in which the ground pressure of the log forwarder is less than about 3 psi when the log forwarder is empty.

6. The log forwarder of claim 1 in which the ground pressure of the log forwarder is less than about 2.5 psi when the log forwarder is empty.

7. The log forwarder of claim 1 in which said endless tracks are about 28 inches wide.

8. The log forwarder of claim 1 in which said endless tracks are about 33 inches wide.

9. The log forwarder of claim 1 in which said flat bed includes vertical rails or vertical sidewalls.

10. The log forwarder of claim 1 further comprising:
said first set of controls oriented towards the front of the log forwarder and said second set of controls oriented towards the back of said log forwarder;
said second set of controls for manipulating said boom includes controls for maneuvering said log forwarder.

11. The log forwarder of claim 1 further comprising an adjustable seat that may be oriented to access said first set of controls or said second set of controls.

12. The log forwarder of claim 1 further comprising a first seat oriented to access said first set of controls and a second seat oriented to access said second set of controls.

13. The log forwarder of claim 1 in which the height of the log forwarder is no more than about 13.6 feet.

14. The log forwarder of claim 1 in which the height of the log forwarder is no more than about 13.6 feet when loaded onto a transportation vehicle having a deck height of about 36 inches.

15. The log forwarder of claim 1 in which the width of the log forwarder is no more than about 8.5 feet wide.

16. The log forwarder of claim 1 in which said elastomeric material is rubber.

17. The log forwarder of claim 1 in which said endless tracks have metal reinforcements.
